(19) United States
(12) Patent Application Publication
(10) Pub. No.: US 2015/0178001 A1
(43) Pub. Date: Jun. 25, 2015

(54) Data Storage Device and Data Maintenance Method Thereof

(71) Applicant: Silicon Motion, Inc., Jhubei City (TW)

(72) Inventors: Jieh-Hsin Chien, Taoyuan City (TW); Hung-Ta Hsu, Kaohsiung City (TW)

(73) Assignee: Silicon Motion, Inc.

(21) Appl. No.: 14/503,938

(22) Filed: Oct. 1, 2014

(30) Foreign Application Priority Data
Dec. 20, 2013 (TW) 102147386

(51) Int. Cl. G06F 3/06

(52) U.S. Cl. CPC G06F 3/0619; G06F 3/0653; G06F 3/0679

(57) ABSTRACT

A data storage device including a flash memory, a temperature sensor, and a controller. The temperature sensor detects surrounding ambient temperature. The controller reads the temperature sensor to obtain a current temperature parameter at a predetermined time, compares a plurality of write temperatures of the blocks with the current temperature parameter one by one, and writes data stored in at least one first block of the blocks into at least one third block of the blocks, wherein the first block corresponds to at least one first write temperature of the write temperatures, and the difference between the first write temperature and the current temperature parameter is greater than a predetermined value.

### CROSS REFERENCE TO RELATED APPLICATIONS

This application claims priority to Taiwan Patent Application No. 102147386, filed on Dec. 20, 2013, the entirety of which is incorporated by reference herein.

### BACKGROUND OF THE INVENTION

1. Field of the Invention

The present invention relates to a data maintenance method applied to a memory device, and in particular to a data maintenance method capable of automatically monitoring flash memory.

2. Description of the Related Art

Flash memory is considered a non-volatile data storage device, using electrical methods to erase and program itself. Taking NAND Flash as an example, it is often used in memory cards, USB flash devices, solid state devices, eMMC and other uses.

Flash memory such as NAND Flash uses a multiple-block structure to store data, wherein the flash memory is constructed by floating gate transistors. The floating gates of the floating gate transistor may catch electronic charges for storing data. However, the floating gates may lose the electronic charges due to their operations, and the various environmental parameters of the flash memory, which can lead to read and write errors.

### BRIEF SUMMARY OF THE INVENTION

A detailed description is given in the following embodiments with reference to the accompanying drawings.

An exemplary embodiment provides a data storage device. The data storage device includes a flash memory, a temperature sensor, and a controller. The flash memory has a plurality of blocks. The temperature sensor is arranged to detect surrounding ambient temperature and produce temperature parameters accordingly. The controller is configured to read the temperature sensor to obtain a current temperature parameter at a predetermined time, compare a plurality of write temperatures of the blocks with the current temperature parameter one by one, and write data stored in at least one first block of the blocks into at least one third block of the blocks, wherein the first block corresponds to at least one first write temperature of the write temperatures, and the difference between the first write temperature and the current temperature parameter is greater than a predetermined value.

Another exemplary embodiment provides a data maintenance method applied to a data storage device of a flash memory, wherein the flash memory has a plurality of blocks. The data maintenance method includes: determining whether a plurality of differences between a plurality of write temperatures corresponding to the blocks and a current temperature parameter are greater than a predetermined value at a predetermined time, wherein the write temperature is the temperature while data is written into the corresponding block; and writing data of at least one first block of the blocks corresponding to a first write temperature of the write temperatures into at least one third block of the blocks by a controller, wherein the difference between the first write temperature and the current temperature parameter is greater than the predetermined value.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an embodiment of an electronic system of an exemplary embodiment;

FIG. 2 is a flowchart of a data maintenance method according to an exemplary embodiment;

FIG. 3 is a flowchart of a data maintenance method according to another exemplary embodiment; and

FIG. 4 is a flowchart of a data maintenance method according to another exemplary embodiment.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

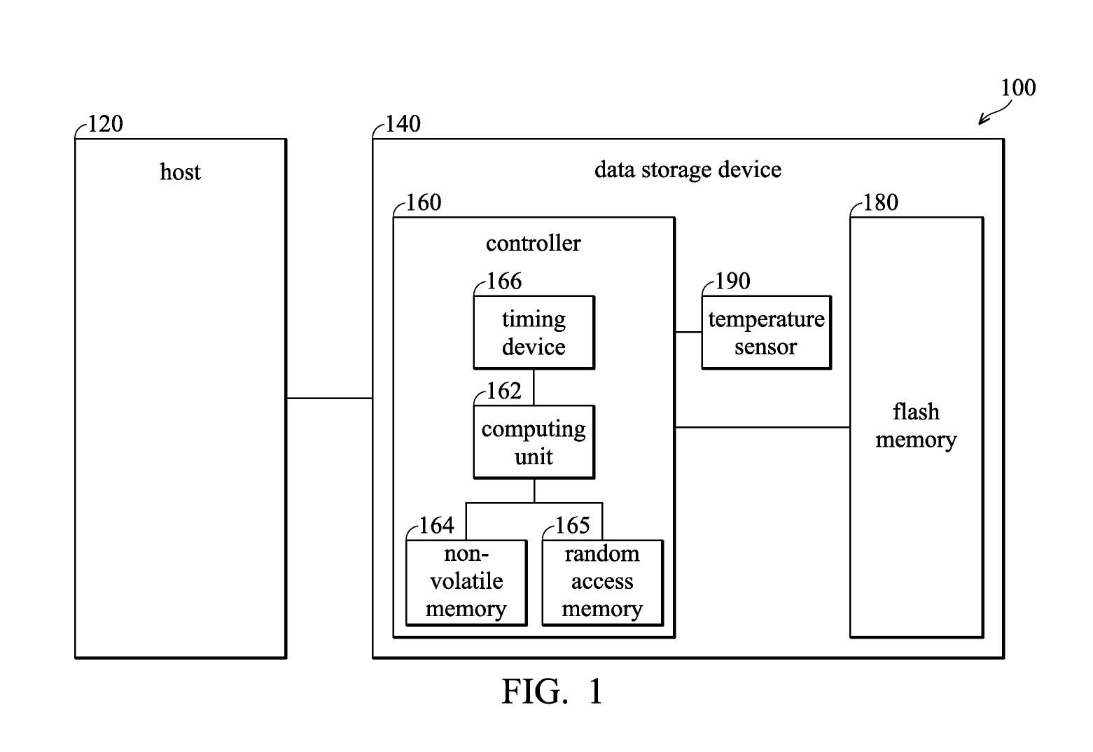

FIG. 1 is a schematic diagram illustrating an embodiment of an electronic system of an exemplary embodiment. The electronic system 100 includes a host 120 and a data storage device 140. The data storage device 140 includes a controller 160, a flash memory 180 and a temperature sensor 190. Furthermore, the data storage device 140 may operate in response to the commands received from the host 120. The controller 160 includes a computing unit 162, a non-volatile memory 164 (such as read only memory), a random access memory 165 and a timing device 166. The program code and data stored in the nonvolatile memory 164 may constitute firmware, and be performed by the computing unit 162, such that the controller 160 may control the flash memory 180 by the firmware. For example, the controller 160 may access the flash memory 180 according to the commands received from the host device 120 and automatically perform the maintenance procedure of the exemplary embodiment. It should be noted that, in one of the embodiments, the maintenance procedure is repeatedly performed in the background. For example, the controller 160 only performs the maintenance procedure when it is idle, and discontinues the maintenance procedure when receiving commands from the host 120 until the operation corresponding to the received command has finished. The flash memory 180 has a plurality of blocks, and each of the blocks has a plurality of pages. The timing device 166 is arranged to record the time that the data storage device 180 was powered on, and the time period between the procedures, etc. The temperature sensor 190 is arranged to detect the surrounding ambient temperature of the data storage device 140, and produce temperature parameters in response to the variation of the surrounding ambient temperature. In this embodiment, the temperature sensor 190 is implemented next to the flash memory 180 of the data storage device 140 and arranged to detect the surrounding ambient temperature of the flash memory 180, but it is not limited thereto. In another embodiment, the temperature sensor 190 may be implemented outside of the data storage device 140 and arranged to detect the surrounding ambient temperature of the data storage device 140.

Moreover, the flash memory 180 is further arranged to store at least one parameter table and at least one scan condition table. In one embodiment, the parameter table is arranged to store the time spans corresponding to the different surrounding ambient temperatures, wherein the time spans are arranged to determine the time interval between the current maintenance procedure and the next maintenance procedure, but it is not limited thereto. In other embodiments, the parameter table further includes the time spans corresponding to the different surrounding ambient temperatures, the different error bit values, the different numbers of the erased blocks, the different times of the last time that the data storage device 140 was accessed by the host 120, the different time spans after the data storage device 140 was powered on, and/or the number of times that the blocks have been erased, wherein the stored time spans are arranged to enable the next maintenance procedure. The scan condition table is arranged to store the scan condition corresponding to the different error bit values and/or the different numbers of updated blocks. For example, the scan condition may be the threshold of the error bit value, but it is not limited thereto. In other embodiments, the scan condition may be the different ECC code. In another embodiment, the flash memory 180 is arranged to store a parameter function and a scan condition function. In this embodiment, the time span between the previous maintenance procedure and the next maintenance procedure is determined by the parameter function. For example, the parameter function calculates the time span between the current maintenance procedure and the following maintenance procedure from the different surrounding ambient temperature values, but it is not limited thereto. In other embodiments, the parameter function is further arranged to calculate the time span between the current maintenance procedure and the following maintenance procedure according to the different surrounding ambient temperatures, the different error bit values, the number of updated blocks, the different times of the last time that the data storage device 140 was accessed by the host 120, the different time spans after the data storage device 140 was powered on and/or the different numbers of times that the blocks are erased. Moreover, the scan condition function is further arranged to determine the different scan conditions according to the different error bit values and/or the number of updated blocks. It should be noted that higher surrounding ambient temperatures, higher error bit values, higher numbers of updated blocks, longer times that the data storage device 140 has been powered on and higher numbers of times that the blocks have been erased have shorter time spans between the current maintenance procedure and the following maintenance procedure. Higher error bit values and higher numbers of updated blocks correspond to lower thresholds of error bit value.

In one embodiment, the controller 160 is arranged to perform a first maintenance procedure after a predetermined period since the data storage device 140 is powered on. In this embodiment, the predetermined period is a predetermined time, but it is not limited thereto. For example, the predetermined period may be 4 minutes or 5 minutes, but it is not limited thereto. In the first maintenance procedure, the controller 160 reads the temperature sensor 190 to obtain a first temperature parameter and determine a first time span according to a first predetermined condition for performing a first block scan on the blocks to obtain a plurality of first error bit values corresponding to the respective blocks. In one embodiment, the first predetermined condition includes the first temperature parameter, but it is not limited thereto. In another embodiment, the first predetermined condition may further include the time of the last time that the data storage device 140 was accessed by the host 120, the time that the data storage device 140 was powered on and/or the number of times that the blocks have been erased. The controller 160 may determine the first time span in the first maintenance procedure according to the parameter table or the parameter function, such that the controller 160 can perform the second maintenance procedure after the first time span since the first maintenance procedure has finished. It should be noted that the parameters of the first predetermined condition are the current detected parameters. Therefore, the parameters of the first maintenance procedure may be different from the parameters of the second maintenance procedure, and the parameters of the second maintenance procedure may be different from the parameters of the third maintenance procedure. In some conditions, the different maintenance procedures may have the same parameters. For example, the number of times that the blocks have been erased in the second maintenance procedure and the third maintenance procedure are the same when the host 120 does not erase the blocks of the flash memory 180 between the second maintenance procedure and the third maintenance procedure. Conversely, the number of the times that the blocks have been erased in the second maintenance procedure is different from the number of the times that the blocks have been erased in the third maintenance procedure when the host 120 erases the blocks of the flash memory 180 between the second maintenance procedure and the third maintenance procedure. It should be noted that the controller 160 is further arranged to update at least one block when the corresponding first error bit value corresponding to the least one block is greater than a predetermined threshold of the error bit value. In this embodiment, the predetermined threshold of the error bit value is a predetermined threshold, but it is not limited thereto.

In another embodiment, in the predetermined period, the controller 160 is further arranged to read the temperature sensor 190 to obtain the current temperature parameter at a predetermined time interval, and adjust the time arranged to start the first maintenance procedure according to the current temperature parameter. Namely, the controller 160 is arranged to read the temperature sensor 190 to obtain the current temperature parameter at a predetermined time interval since the data storage device 140 is powered on, and determine the time arranged to start the first maintenance procedure by looking it up in the parameter table or the parameter function according to the current temperature parameter, wherein the span of the predetermined time interval is shorter than the predetermined period. For example, the predetermined period may be 1 second or 2 seconds, etc., but it is not limited thereto. When the determined time arranged to start the first maintenance procedure is less than the predetermined period, the controller 160 is further arranged to adjust the predetermined period according to the determined time arranged to start the first maintenance procedure. For example, the predetermined period may be 5 minutes, and the span of each predetermined time interval is 2 seconds. The controller 160 is arranged to read the temperature sensor 190 to obtain the current temperature parameter every 2 seconds for 5 minutes after the data storage device 140 is powered on, and determine the time arranged to enable the first maintenance procedure according to the current temperature parameter. For example, when the controller 160 determines that the first maintenance procedure should be started after 6 minutes (longer than the predetermined period) from the powering on of the data storage device 140, the controller 160 ignores the determined time (6 minutes) and repeats the steps of reading the temperature sensor 190 and determining the time span every 2 seconds until the predetermined period has ended. When the controller 160 determines that the first maintenance procedure should be started after 3 minutes (shorter than the predetermined period) from the data storage device 140 being powered on, the controller 160 adjusts the predetermined period to be 3 minutes and repeats the steps of reading the temperature sensor 190 and determining the time span every 2 seconds until the predetermined period has ended. Namely, the controller 160 performs the first maintenance procedure after 3 minutes since the data storage device 140 was powered on, and so on.

The controller 160 is further arranged to perform the second maintenance procedure after the first time span since the first maintenance procedure has finished. In the second maintenance procedure, the controller 160 reads the temperature sensor 190 to obtain a second temperature parameter, determines a second time span according to a second predetermined condition and a first history record to perform a third maintenance procedure, and determines a first threshold for the error bit value according to the first history record to perform a second block scan on the blocks. In one embodiment, the second predetermined condition includes the second temperature parameter, and the first history record includes the first error bit values and the number of times that the blocks have been erased during the first maintenance procedure, but it is not limited thereto. In other embodiments, the second predetermined condition may further include the time of the last time that the data storage device 140 was accessed by the host 120, the time that the data storage device 140 was powered on and/or the number of times that the blocks have been erased. The controller 160 may determine the second time span in the second maintenance procedure according to the parameter table or the parameter function, and perform the third maintenance procedure after the second time span since the second maintenance procedure has finished. It should be noted that the parameters of the first predetermined condition are the current detected parameters, and the operations of the third maintenance procedure and the second maintenance procedure are the same. Similarly, the third maintenance procedure may determine a third time span for determining the time arranged to start the fourth maintenance procedure, and determine a second threshold for the error bit value for performing a third block scan on the blocks. The operations of the fourth maintenance procedure and the second maintenance procedure are the same, and so on. It should be noted that the controller 160 is further arranged to update the blocks when the second error bit values of the blocks are greater than the first threshold of the error bit value.

It should be noted that the controller 160 may store the results of the block scan (such as the error bit values and/or the number of updated blocks) or the number of times that the blocks have been erased (erase counts) in at least one specific block of the flash memory 180 for providing the maintenance procedure, but it is not limited thereto. In the block scan, the controller 160 is arranged to scan each of the blocks of the flash memory 180 to obtain the error bit values corresponding to the respective blocks. More specifically, the controller 160 is arranged to read each of the blocks of the flash memory 180 and obtain the error bit values of the Error Correction (ECC) of each block. Next, the controller 160 is further arranged to update the blocks when the corresponding error bit value is greater than a threshold, such as the predetermined threshold of the error bit value, the first threshold of the error bit value, and the second threshold of the error bit value, etc. It should be noted that the threshold of the error bit value is less than the maximum of the error bit value that can be corrected by the Error Correction (ECC). For example, the data can be corrected by the Error Correction (ECC) when the error bit is less than 43 bits, and the threshold of the error bit value may be 35 bit or 38 bit, but it is not limited thereto. Persons with skill in the art may determine the predetermined threshold of the error bit value according to the maximum of the error bit value that can be corrected by the Error Correction (ECC).

In another embodiment, the controller 160 is arranged to perform a table-checking-maintenance procedure at a predetermined time. In the table-checking-maintenance procedure, the controller 160 is configured to read the temperature sensor 190 to obtain a current temperature parameter and compare a plurality of write temperatures of the blocks with the current temperature parameter one by one. Next, the controller 160 is further configured to write data stored in at least one first block of the blocks into at least one third block of the blocks, wherein the difference between the first write temperature of the first block and the current temperature parameter is greater than a predetermined value. Namely, the controller 160 is further configured to perform the read refresh or read retirement procedure on a block when the difference between the write temperature of the block and the current temperature parameter is greater than the predetermined value to move the data stored in the block to another block.

It should be noted that the predetermined time arranged to perform the table-checking-maintenance procedure is while the controller 160 is idle, a time interval while the controller 160 is idle, or while the controller 160 finishes a writing operation or a reading operation, but it is not limited thereto. For example, the time interval may be 1 second, 2 seconds, 3 seconds, 1 minute, or 10 minutes, etc., but it is not limited thereto. Moreover, when the controller 160 receives commands from the host 120 in the table-checking-maintenance procedure, the controller 160 stores the parameters of the current status of the table-checking-maintenance procedure in the flash memory 180 or the random access memory 165 and continues to perform the table-checking-maintenance procedure according to the stored parameters after the commands received from the host 120 are finished. In another embodiment, the predetermined time arranged to perform the table-checking-maintenance procedure follows the first maintenance procedure, the second maintenance procedure or the third maintenance procedure. In one embodiment, the table-checking-maintenance procedure may be included in the first maintenance procedure, the second maintenance procedure and/or the third maintenance procedure, but it is not limited thereto.

Moreover, each of the blocks of the flash memory 180 has a physical block and a logical block, the controller 160 and the flash memory 180 may locate the physical block by the corresponding logical block, wherein the flash memory 180 further includes a logical-to-physical mapping table arranged to store the mapping relationships of the logical blocks and the physical blocks.

In one embodiment, the write temperature is recorded according to the relationships of the logical blocks. For example, the flash memory 180 further includes a write temperature correspondence table arranged to store the relationships between the write temperatures and the logical blocks. Furthermore, the controller 160 is configured to obtain the write temperatures of the logical blocks from the write temperature correspondence table and locate the physical blocks corresponding to the logical blocks according to the logical-to-physical mapping table, such that the write temperatures of the physical blocks can be found, but it is not limited thereto. In another embodiment, the write temperature correspondence table is arranged to store the write temperatures of the physical blocks.

Moreover, the controller 160 is configured to load the write temperature correspondence table into the random access memory 165 and update the write temperature correspondence table stored in the flash memory 180 by the write temperature correspondence table stored in the random access memory 165 while the controller 160 is idle or the write temperature correspondence table changes, but it is not limited thereto.

It should be noted that, in this embodiment, the controller 160 is further configured to take a temperature of the surrounding ambient temperature when the data is written into a target block to serve as the write temperature of the target block, and write the write temperature of the target block into the write temperature correspondence table. Moreover, in one embodiment, the columns arranged to store the write temperatures of blocks can be filled by a predetermined parameter when the corresponding blocks do not have data, such that the controller 160 can determine whether the blocks have been written according to the predetermined parameter, but it is not limited thereto. In other embodiment, the columns arranged to store the write temperatures can be filled by the write temperatures of when the data was last written into the blocks when the blocks have no data.

Moreover, the controller 160 is further configured to update the logical-to-physical mapping table after the data of the block is moved to another block when the difference between the write temperature of the block and the current temperature parameter is greater than a predetermined value, such that the logical block of the block which has a write temperature greater or less than the current temperature parameter by the predetermined value can be mapped to the physical block of another block.

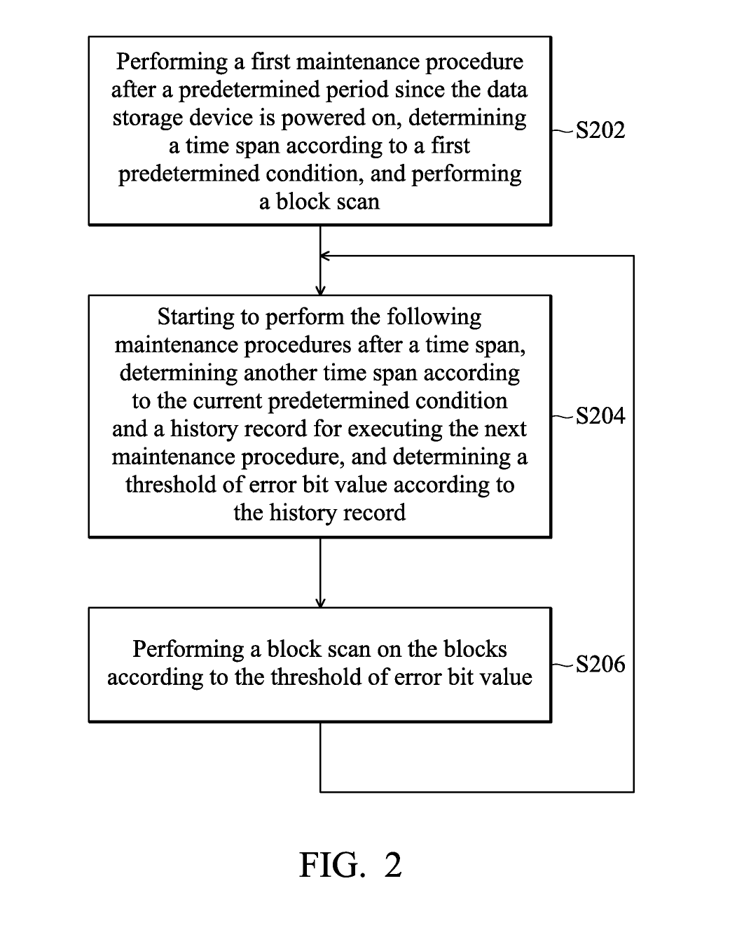

FIG. 2 is a flowchart of a data maintenance method according to an exemplary embodiment. The data maintenance method is applied to the data storage device 140 of FIG. 1. The process starts at step S202.

In step S202, the controller 160 is arranged to perform a first maintenance procedure after a predetermined period since the data storage device 140 was powered on. In this embodiment, the predetermined period is a predetermined time, but it is not limited thereto. For example, the predetermined period may be 4 minutes or 5 minutes, but it is not limited thereto. In the first maintenance procedure, the controller 160 reads the temperature sensor 190 to obtain a first temperature parameter and determines a first time span according to a first predetermined condition for performing a first block scan on the blocks to obtain a plurality of first error bit values corresponding to the respective blocks. In one embodiment, the first predetermined condition includes the first temperature parameter, but it is not limited thereto. In another embodiment, the first predetermined condition may further include the time of the last time that the data storage device 140 was accessed by the host 120, the time that the data storage device 140 was powered on and/or the number of times that the blocks are erased. The controller 160 may determine the time span in the first maintenance procedure according to the parameter table or the parameter function, such that the controller 160 can perform the following maintenance procedures after the determined time span since the first maintenance procedure was finished, the following maintenance procedures may include the first maintenance procedure, the second maintenance procedure, and the third maintenance procedure, etc. It should be noted that the parameters of the first predetermined condition are the current detected parameters. It should be noted that the controller 160 is further arranged to update at least one block when the corresponding first error bit value corresponding to the at least one block is greater than a predetermined threshold of the error bit value. In this embodiment, the predetermined threshold of the error bit value is a predetermined threshold, but it is not limited thereto.

Next, after a time span, the controller 160 starts to perform the following maintenance procedures. For example, the controller 160 performs the second maintenance procedure after a time span determined by step S202 since the first maintenance procedure finished. First, in step S204, the controller 160 reads the temperature sensor 190 to obtain the current temperature parameter. Furthermore, the controller 160 determines another time span according to the current predetermined condition and a history record for executing the next maintenance procedure, and determines a threshold for the error bit value according to the history record. In one embodiment, the predetermined condition includes the current temperature parameter, and the history record includes the error bit value of the previous block scan and the number of updated blocks in the previous maintenance procedure, but it is not limited thereto. In other embodiments, the current predetermined condition may further include the time of the last time that the data storage device 140 is accessed by the host 120, the time that the data storage device 140 was powered on and/or the number of times that the blocks are erased. In the current maintenance procedure, the controller 160 may determine the time span according to the parameter table or the parameter function, such that the controller 160 can perform the following maintenance procedure after the determined time span since the current maintenance procedure is finished.

Next, in step S206, the controller 160 performs a block scan on the blocks according to the threshold of the error bit value, wherein the controller 160 is arranged to perform the block scan on the blocks to obtain the error bit values corresponding to the respective blocks, and update the blocks when the corresponding error bit value is greater than the threshold of the error bit value. Next, the process returns to step S204.

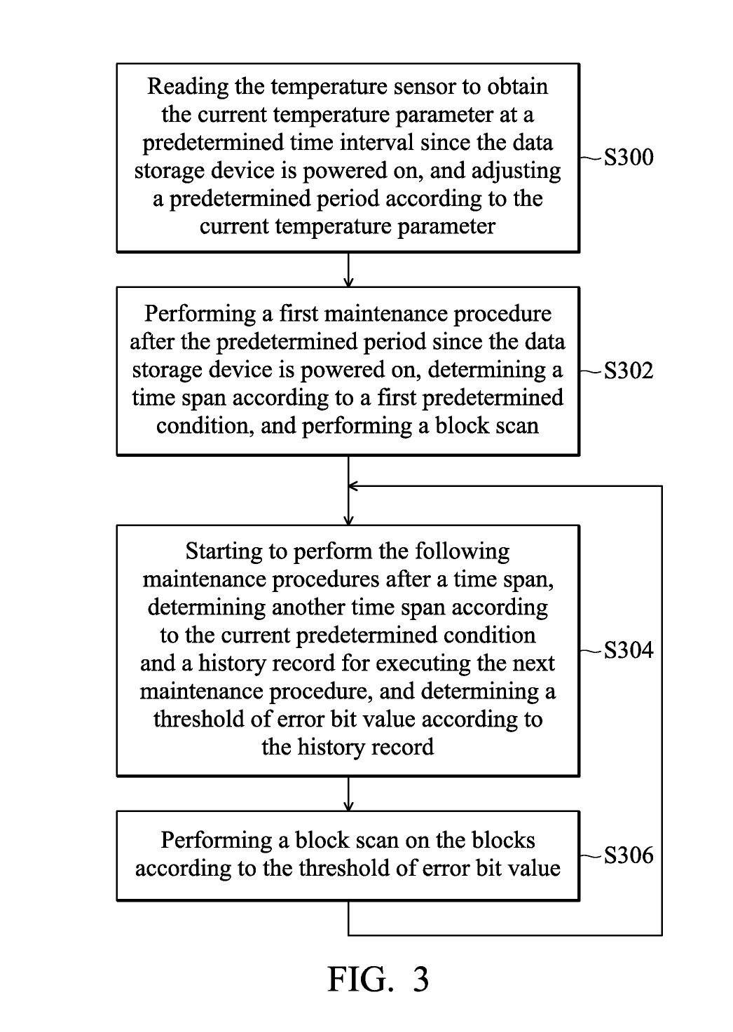

FIG. 3 is a flowchart of an access restriction method according to another embodiment of the present invention. The data maintenance method is applied to the data storage device 140 of FIG. 1. The process starts at step S300. It should be noted that the data maintenance method of FIG. 3 is similar to the data maintenance method of FIG. 2, except for step S300. Therefore, the details of steps S302-S306 can be referred to in steps S202-S206.

In step S300, the controller 160 is arranged to read the temperature sensor 190 to obtain the current temperature parameter at a predetermined time interval since the data storage device 140 was powered on, and adjust the predetermined period according to the current temperature parameter, wherein the predetermined period is arranged to start the first maintenance procedure. Namely, the controller 160 is arranged to read the temperature sensor 190 to obtain the current temperature parameter at a predetermined time interval since the data storage device 140 is powered on, and determine the time arranged to start the first maintenance procedure by looking it up in the parameter table or the parameter function according to the current temperature parameter, wherein the span of the predetermined time interval is shorter than the predetermined period. For example, the predetermined period may be 1 second or 2 seconds, etc., but it is not limited thereto. When the determined time arranged to start the first maintenance procedure is less than the predetermined period, the controller 160 is further arranged to adjust the predetermined period according to the determined time arranged to start the first maintenance procedure. For example, the predetermined period may be 5 minutes, and the span of each predetermined time interval is 2 seconds. The controller 160 is arranged to read the temperature sensor 190 to obtain the current temperature parameter every 2 seconds for 5 minutes since the data storage device 140 was powered on, and determine the time arranged to enable the first maintenance procedure according to the current temperature parameter. For example, when the controller 160 determines that the first maintenance procedure should be started after 6 minutes (longer than the predetermined period) from the data storage device 140 being powered on, the controller 160 ignores the determined time (6 minutes) and repeats the steps of reading the temperature sensor 190 and determining the time span every 2 seconds until the predetermined period has ended. When the controller 160 determines that the first maintenance procedure should be started after 3 minutes (shorter than the predetermined period) from the data storage device 140 being powered on, the controller 160 adjusts the predetermined period to be 3 minutes and repeats the steps of reading the temperature sensor 190 and determining the time span every 2 seconds until the predetermined period has ended. Namely, the controller 160 performs the first maintenance procedure after 3 minutes since the data storage device 140 was powered on, and so on.

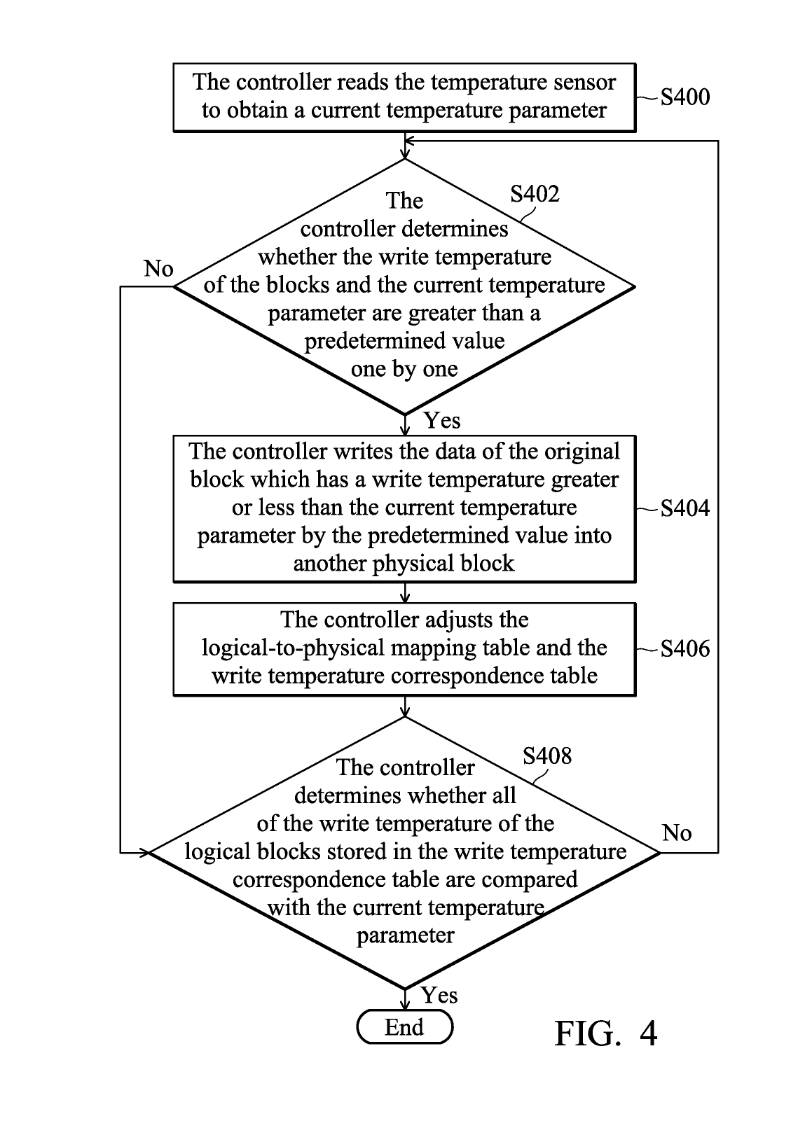

FIG. 4 is a flowchart of a data maintenance method according to another exemplary embodiment. The data maintenance method is applied to the data storage device 140 of FIG. 1. The data maintenance method is arranged to perform a table-checking-maintenance procedure (Steps S400˜S408) at a predetermined time. It should be noted that the predetermined time arranged to perform the table-checking-maintenance procedure is while the controller 160 is idle, a time interval while the controller 160 is idle, or while the controller 160 finish a writing operation or a reading operation, but it is not limited thereto. For example, the time interval may be 1 second, 2 seconds, 3 seconds, 1 minute, or 10 minutes, etc., but it is not limited thereto. Moreover, when the controller 160 receives commands from the host 120 in the table-checking-maintenance procedure, the controller 160 stores the parameters of the current status of the table-checking-maintenance procedure in the flash memory 180 or the random access memory 165 and continues to perform the table-checking-maintenance procedure according to the stored parameters after the commands received from the host 120 are finished. In another embodiment, the predetermined time arranged to perform the table-checking-maintenance procedure follows the first maintenance procedure, the second maintenance procedure or the third maintenance procedure. In one embodiment, the table-checking-maintenance procedure may be included in the first maintenance procedure, the second maintenance procedure and/or the third maintenance procedure. The process starts at step S400.

In step S400, the controller 160 is configured to read the temperature sensor 190 to obtain a current temperature parameter.

Next, in step S402, the controller 160 is configured to determine whether the write temperatures of the blocks and the current temperature parameter are greater than a predetermined value, one by one. In one embodiment, the predetermined value may be 50 degrees Celsius, but it is not limited thereto. In other embodiment, the predetermined value may be any rational value between 30 and 100 degrees Celsius. In one embodiment, the controller 160 is configured to read each of the write temperatures corresponding to the logical blocks of the write temperature correspondence table in sequence and compare the read write temperatures and the current temperature parameter one by one. When the difference between the current temperature parameter and the read write temperature is greater than the predetermined value, the process goes to step S404, otherwise, the process goes to step S408.

In step S404, the controller 160 is configured to write the data of the original block which has a write temperature greater or less than the current temperature parameter by the predetermined value into another physical block.

Next, in step S406, the controller 160 is configured to adjust the logical-to-physical mapping table and the write temperature correspondence table. More specifically, the controller 160 is configured to adjust the logical-to-physical mapping table for mapping the logical block of the original block to the physical block which is written by the data of the original block. Moreover, the controller 160 is configured to adjust the write temperature correspondence table for updating the write temperature of the original logical block by the write temperature when the data is written into the physical block in step S404.

Next, in step S408, the controller 160 is configured to determine whether all of the write temperatures of the logical blocks stored in the write temperature correspondence table are compared with the current temperature parameter. When all of the write temperatures of the logical blocks are compared with the current temperature parameter, the process ends at step S408, otherwise, the process returns to step S402.

The data storage device 140 and the data maintenance method can record the temperatures while data is written into each block and accordingly update the block.

Data transmission methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a flash memory, having a plurality of blocks;
a temperature sensor, arranged to detect surrounding ambient temperature and produce temperature parameters accordingly; and
a controller, configured to read the temperature sensor to obtain a current temperature parameter at a predetermined time, compare a plurality of write temperatures of the blocks with the current temperature parameter one by one, and write data stored in at least one first block of the blocks into at least one third block of the blocks, wherein the first block corresponds to at least one first write temperature of the write temperatures, and a difference between the first write temperature and the current temperature parameter is greater than a predetermined value.

2. The data storage device as claimed in claim 1, wherein each of the blocks has a physical block and a logical block, and the write temperatures correspond to the logical blocks of the blocks respectively.

3. The data storage device as claimed in claim 2, wherein the flash memory further comprises a write temperature correspondence table arranged to store relationships of the write temperatures and the logical blocks.

4. The data storage device as claimed in claim 3, wherein the controller is further configured to take a temperature of the surrounding ambient temperature when the data is written into the third block to serve as the write temperature of the third block, and write the write temperature of the third block in to the write temperature correspondence table.

5. The data storage device as claimed in claim 3, wherein the flash memory further comprises a logical-to-physical mapping table, the controller is further configured to update the logical-to-physical mapping table, such that the logical block of the first block is mapped to the physical block of the third block.

6. The data storage device as claimed in claim 1, wherein the predetermined time is while the controller is idle.

7. The data storage device as claimed in claim 1, wherein the predetermined time is a time interval while the controller is idle.

8. The data storage device as claimed in claim 1, wherein the predetermined time is while the controller finishes a writing operation or a reading operation.

9. A data maintenance method, applied to a data storage device of a flash memory, wherein the flash memory has a plurality of blocks, and the data maintenance method comprises:
determining whether a plurality of differences between a plurality of write temperatures corresponding to the blocks and a current temperature parameter are greater than a predetermined value at a predetermined time, wherein the write temperature is the temperature while data is written into the corresponding block; and
writing data of at least one first block of the blocks corresponding to a first write temperature of the write temperatures into at least one third block of the blocks by a controller, wherein the difference between the first write temperature and the current temperature parameter is greater than the predetermined value.

10. The data maintenance method as claimed in claim 9, wherein each of the blocks has a physical block and a logical block, and the write temperatures correspond to the logical blocks of the blocks respectively.

11. The data maintenance method as claimed in claim 10, further comprising taking a temperature when the data is written into the third block to serve as the write temperature of the third block, and write the write temperature of the third block in to a write temperature correspondence table.

12. The data maintenance method as claimed in claim 11, further comprising a logical-to-physical mapping table arranged to map the logical block of the first block to the physical block of the third block.

13. The data maintenance method as claimed in claim 9, wherein the predetermined time is while the controller is idle.

14. The data maintenance method as claimed in claim 9, wherein the predetermined time is a time interval while the controller is idle.

15. The data maintenance method as claimed in claim 9, wherein the predetermined time is while the controller finishes a writing operation or a reading operation.
